(19) United States
(12) Patent Application Publication
(10) Pub. No.: US 2024/0333757 A1
(43) Pub. Date: Oct. 3, 2024

(54) Malicious Attack Protection For Vehicle Networks

(71) Applicant: THE REGENTS OF THE UNIVERSITY OF MICHIGAN, Ann Arbor, MI (US)

(72) Inventors: Kang G. SHIN, Ann Arbor, MI (US); Mert D. Pese, Easley, SC (US)

(73) Assignee: THE REGENTS OF THE UNIVERSITY OF MICHIGAN, Ann Arbor, MI (US)

(21) Appl. No.: 18/623,296

(22) Filed: Apr. 1, 2024

Related U.S. Application Data
(60) Provisional application No. 63/456,717, filed on Apr. 3, 2023.

(51) Int. Cl. H04L 9/40

(52) U.S. Cl. CPC H04L 63/1441; H04L 63/1416

(57) ABSTRACT

A system for detecting and preventing, in real time, malicious broadcasting messages from an electronic control module attempting to attack a vehicle network is disclosed. The system includes electronic control modules in communication via a serial data link of the vehicle network. At least one electronic control module is configured to receive at least a portion of a serial message on the vehicle network transmitted by another electronic control module, identify the serial message as malicious based on the received portion of the serial message, and in response to identifying the serial message as malicious, inject a dominant bit into the serial message for the vehicle network to cause an error frame in the serial message. Other example systems and methods for detecting and preventing, in real time, malicious broadcasting messages are also disclosed.

### CROSS-REFERENCE TO RELATED APPLICATIONS

This application claims the benefit of U.S. Provisional Application No. 63/456,717, filed on Apr. 3, 2023. The entire disclosure of the above application is incorporated herein by reference.

### FIELD

The present disclosure relates to malicious attack protection for vehicle networks.

### BACKGROUND

Controller Area Network (CAN) has been the de facto in-vehicle network (IVN) protocol for decades. In such configurations, various electronic control units (ECUs) are connected, and exchange information, with each other via a CAN bus. CAN was designed without security in mind and its vulnerabilities have often been exploited. For example, traffic in the standard CAN is in plain text, and includes no provisions of sender or message authentication. As such, CAN is highly susceptible to availability attacks, such as Denial-of-Service (DOS).

This section provides background information related to the present disclosure which is not necessarily prior art.

### SUMMARY

This section provides a general summary of the disclosure, and is not a comprehensive disclosure of its full scope or all of its features.

According to one example embodiment, a system for detecting and preventing, in real time, malicious broadcasting messages from an electronic control module attempting to attack a vehicle network is disclosed. The system includes a plurality of electronic control modules in communication via a serial data link of the vehicle network. At least a first electronic control module of the electronic control modules is configured to receive at least a portion of a serial message on the vehicle network transmitted by a second electronic control module of the plurality of electronic control modules, identify the serial message from the second electronic control module as malicious based on the received portion of the serial message, and in response to identifying the serial message as malicious, inject a dominant bit into the serial message for the vehicle network to cause an error frame in the serial message transmitted by the second electronic control module.

According to another example embodiment, a method for detecting and preventing, in real time, malicious broadcasting messages from an electronic control module attempting to attack a vehicle network is disclosed. The method includes receiving, by at least a first electronic control module of a plurality of electronic control modules in communication via a serial data link of the vehicle network, a portion of a serial message on the vehicle network transmitted by a second electronic control module of the plurality of electronic control modules, identifying the serial message from the second electronic control module as malicious based on the received portion of the serial message, and in response to identifying the serial message as malicious, injecting a dominant bit into the serial message for the vehicle network to cause an error frame in the serial message transmitted by the second electronic control module.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a block diagram of a data frame of an example CAN message, according to one example embodiment of the present disclosure.

FIG. 2 is a block diagram of an example state diagram for CAN error handling, according to one example embodiment of the present disclosure.

FIG. 3 is a block diagram of an example overview of an evolution of CAN hardware in ECUs, according to one example embodiment of the present disclosure.

FIG. 4 is a block diagram of a traditional DOS attack, according to one example embodiment of the present disclosure.

FIG. 5 is a block diagram of a targeted DOS attack, according to one example embodiment of the present disclosure.

FIG. 6 is a block diagram of a spoofing attack, according to one example embodiment of the present disclosure.

FIG. 7 is a block diagram of a DOS attack, according to one example embodiment of the present disclosure.

FIG. 8 is a block diagram of a miscellaneous attack, according to one example embodiment of the present disclosure.

FIG. 9 is a diagram of an example binary tree for labeling globally malicious bits, according to one example embodiment of the present disclosure.

FIG. 10 is a diagram of an example algorithm for finding and marking globally malicious bits, according to one example embodiment of the present disclosure.

FIG. 11 is a diagram of an example algorithm for identifying malicious outliers, according to one example embodiment of the present disclosure.

FIG. 12 is a diagram of an example algorithm for generating local prefixes, according to one example embodiment of the present disclosure.

FIG. 13 is a diagram of an example algorithm for generating finite state machine code, according to one example embodiment of the present disclosure.

FIG. 14 is a diagram of a listing of example C++ code for uploading to an ECU, according to one example embodiment of the present disclosure.

FIG. 15 is a block diagram of a system including two ECUs in communication via a CAN bus, according to one example embodiment of the present disclosure.

FIG. 16 is a diagram of an example algorithm for identifying a CAN message as malicious, according to one example embodiment of the present disclosure.

FIG. 17 is a block diagram of an example prevention routine showing a stuff bit of an attacker's CAN message being overwritten by a dominant bit, according to one example embodiment of the present disclosure.

FIGS. 18-19 are graphs showing CPU loads with respect to different vehicles, according to one example embodiment of the present disclosure.

Corresponding reference numerals indicate corresponding parts and/or features throughout the several views of the drawings.

### DETAILED DESCRIPTION

Example embodiments will now be described more fully with reference to the accompanying drawings.

CAN has been the de facto IVN protocol for decades. However, CAN was designed without security in mind and its vulnerabilities have often been exploited through attacks, such as DOS attacks and spoofing attacks, that threaten the availability of safety-critical vehicle operations. To address such vulnerabilities, countermeasures have been developed to provide the security properties of confidentiality, authenticity, integrity and availability.

Most known CAN security countermeasures focus on authentication. For example, some countermeasures focus on the prevention of CAN spoofing attacks, using message authentication codes (MACs) to support message integrity. Other countermeasures focus on the prevention of sniffing attacks by relying on an encrypted CAN payload. Such schemes use cryptography which imposes heavy computation loads on resource-constrained ECUs and incurs a significant computation delay.

The easiest and thus riskiest CAN availability attack is a DoS attack. DOS attacks target the CAN message identifier (e.g., a CAN ID) by injecting CAN messages with low CAN IDs. Since CAN is a multi-master broadcast protocol and lower CAN IDs indicate higher priority, the injected CAN messages with low CAN IDs will always win arbitration and be allowed to transmit before higher ID messages on the CAN bus. By continuously sending CAN messages with a low ID, higher ID messages will always lose arbitration and thus become unavailable on the CAN bus. Attackers can choose to make the transmission of all ECUs unavailable (e.g., a traditional DOS attack) or selectively choose which ECUs to silence (e.g., a targeted DOS attack). For instance, a traditional DoS attacker may continuously inject CAN messages with ID 0x0 to block other ECUs' communications on CAN. The major impact of a DOS attack could be safety-critical, especially when the vehicle can no longer perform certain powertrain control functions. However, some vehicles may implement a limp mode which still allows certain safety-critical ECUs to work with limited functionality in the event of losing CAN communication. Another impact of a DOS attack could be ransomware which is financially motivated. A targeted DOS attack can shut down ECUs with a high CAN ID (and thus low priority). This would mostly affect convenience features such as remote keyless entry (RKE) or advanced driver assistance systems (ADAS). In modern vehicles, the loss of RKE could also prevent anti-theft systems from being disengaged and the car from being started. The victim of such attack would either need to pay ransom to the attacker or take his/her car to the dealership to reset/reflash the affected ECU(s), which will cost time and money.

As recognized by the subject inventors, known countermeasures to detect and possibly prevent availability attacks (e.g., DOS attacks, etc.) are inadequate and therefore have not been adopted/implemented in the production of vehicles. This is due to, for example, their inability of real-time detection and prevention of such attacks, lack of backward compatibilities, and increased traffic overhead on ECUs and the CAN bus.

For example, known countermeasures often require a hardware-based message firewall that can defend against various spoofing and DoS attacks. However, this introduces a stand-alone device (e.g., intermediate hardware) deployed between a high-risk ECU (e.g., the ECU with the highest risk to be compromised) and the CAN bus which limits its backward compatibility.

Additionally, known countermeasures are incapable of detecting attacks in real time. For instance, some known countermeasures incur an additional propagation time because the intermediate hardware must both decode and re-encode the message before passing it to the main bus. Other known countermeasures for spoofing detection and prevention require each ECU to monitor the CAN bus to detect frames with its own CAN ID. If a CAN message with the same CAN ID that is not sent by the ECU itself is detected on the CAN bus, such countermeasures launch a counterattack to bus off the attacking ECU. However, it incurs an additional delay in launching a counterattack (e.g., bus-off time) because it only starts destroying an attacker message after its second instance, with the first instance used for detection.

Known countermeasures also increase traffic overhead on ECUs and the CAN bus. For instance, a bus load of CAN represents how busy the bus is at any given time. To avoid the difficulty/problem of scheduling messages (with safety-critical implications), it is desirable to keep the bus load as low as possible, with 30% being a recommended upper bound. However, when known countermeasures launch a counterattack, they need to start at the exact same time as the second instance of the attacker's CAN message as referenced above. As a result, such countermeasures flood the CAN bus with counterattack messages to collide with the attacker's CAN messages in a brute-force fashion. In such scenarios, the bus load can reach up to 100% during those times, making such countermeasures unusable in real production vehicles.

Further, some known countermeasures merely detect an attack without eradicating the attack. In such scenarios, just detecting an attack without eradication is not helpful as all subsequent communications will be halted.

The present disclosure provides novel distributed, backward-compatible and real-time defense solutions (sometimes referred to as “MichiCAN”) against DoS and spoofing attacks by using new integrated/on-chip CAN controllers which are becoming popular and widely deployed in real-world microcontroller units (MCUs). Such integrated CAN controllers allow the MCUs to bypass the CAN controllers, thereby enabling bit-level read and write access to each message (e.g., bit banging) on the CAN bus, as further explained herein. For example, MichiCAN can detect incoming DOS attack messages during the CAN arbitration phase with a 100% detection rate and eradicate the attack by busing off the attacker ECU in the least possible time under the CAN protocol. As such, MichiCAN enables both detection and prevention of an availability attack in real time (e.g., at the first instance/message of the attack), while providing backward compatibility (e.g., based on software) for use in new and existing ECUs (or electronic control modules (ECMs)). As a result, MichiCAN quickly detects and eradicates availability attacks without requiring additional hardware or modifications of existing hardware and without increasing a bus load.

For example, and as further explained herein, each ECU (or ECM) equipped with MichiCAN stores a list of legitimate CAN IDs from the set E of all participating ECUs in the IVN. In such examples, a CAN node ECUᵢ (e.g., one ECU) of the set E can detect a spoofing attack if its own CAN ID is transmitted by another node (e.g., another ECU). The CAN node ECUᵢ can also mark a message with a CAN ID lower than its own as a DOS attack on other ECUs generating lower-priority messages than itself, e.g., other lower legitimate CAN IDs originating from other ECUs stored in the list are not affected. After marking the incoming CAN message as malicious, the CAN node ECUᵢ starts a counterattack. Using the inherent weaknesses in the CAN error handling mechanism, it will eventually force the attacking ECU into a bus-off state, thus stopping the attacking ECU from transmitting or receiving any CAN messages.

One challenge in busing off an attacker ECU is the timing of counterattack. Since the application software can only send and receive complete CAN frames, the “defender” ECU (e.g., the CAN node ECUᵢ) needs to know precisely when to start the counterattack so its message can exactly synchronize with the attacker's CAN message. This is a deficiency of known countermeasures. In contrast, MichiCAN leverages the integrated CAN controller of ECUs which allows the application software to gain direct read/write access to each individual bit of a CAN frame. This technique is called bit banging. As a result, MichiCAN will correctly synchronize to the CAN bus and start the counterattack at any given time, without flooding the CAN bus to determine the correct start time. As a result, employing MichiCAN does not cause an increase of the bus load. Furthermore, by sampling the CAN ID bit-by-bit, MichiCAN is able to detect a spoofing or DOS attack before the end of the 11-bit CAN ID field. This will allow MichiCAN to launch the counterattack much faster as compared to known countermeasures, thus reducing the required bus-off time for the attacking ECU.

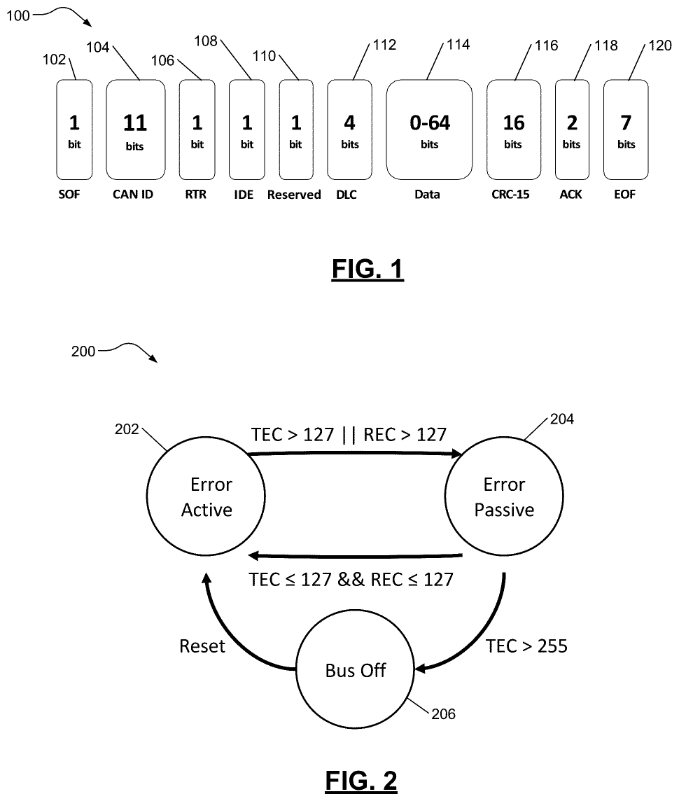

Vehicular sensor data is collected from ECUs located within a vehicle. These ECUs are typically interconnected via an IVN, with a CAN bus being the most widely-deployed technology in current vehicles. FIGS. 1-3 illustrate various diagrams associated with CAN, including a common CAN data frame structure, a state diagram for CAN error handling, and an example evolution of CAN hardware in ECUs.

For example, FIG. 1 depicts a CAN 2.0A data frame (e.g., a CAN message) 100. As shown, the structure 100 includes multiple fields 102, 104, 106, 108, 110, 112, 114, 116, 118, 120. The field 102 represents a start-of-frame (SOF) bit indicating the beginning of a new CAN frame/message and is always set to 0.

The field 104 represents a CAN ID indicating the meaning and priority of the CAN message. For example, CAN is a multi-master, message-based broadcast bus which is message-oriented. In other words, CAN message frames do not contain any information concerning their source or destination ECUs, but instead each frame (e.g., the frame 100) carries a unique message identifier (ID) that represents its meaning and priority. Lower CAN IDs have higher priority (e.g., powertrain vs. body-related information) and will “win” the distributed arbitration process that occurs when multiple messages are sent on the CAN bus at the same time. The reason behind this is the wired-AND logic of CAN. A dominant “0” bit will always overwrite a recessive “1” bit. It is possible for the same ECU to send and/or receive messages with different CAN IDs. The basic CAN ID in the CAN 2.0A specification is 11 bits long and thus allows for up to 2048 different CAN IDs.

The fields 106, 108, 110 represent a remote transmission request (RTR) bit, an identifier extension (IDE) bit, and a reserved (r0) bit, respectively. The RTR bit (field 106) and the reserved (r0) bit (field 110) are always set to 0 for data frames. Additionally, the IDE bit (field 108) is set to 0 for 11-bit IDs.

The field 112 represents a data length code (DLC). For example, the field 112 specifies the number of (e.g., up to 8) bytes in a payload (data) field of the frame/message 100.

The field 114 represents the payload (data) field in the frame/message 100. The payload field of a CAN message contains the actual message data. In various embodiments, the payload field may contain 0 bytes to 8 bytes (e.g., 64 bits) of data depending on the value of the DLC in the field 112.

The field 116 represents a cyclic redundancy check (CRC). In various embodiments, the CRC is calculated over all previous fields to detect transmission errors.

The fields 118, 120 represent an acknowledgment (ACK) field and an end-of-frame (EOF) field, respectively. The ACK field includes two bits. The first bit of the ACK field is called an ACK slot and the second bit of the ACK field is called an ACK delimiter. The ACK slot is always set to 1 for the transmitting ECU. If the receivers do not observe any errors in the frame, they send a 0 during this slot. Due to the wired-AND logic, at least one receiver needs to transmit a 0, acknowledging the correct receipt of the CAN frame. If the transmitter (which reads back this slot) detects that nobody acknowledged this frame by sending a 0, it will retransmit the frame. The ACK delimiter and the EOF field is always set to 1. After the transmission of a CAN frame, the next CAN frame has to wait another 3 bits (not depicted in FIG. 1) which is called inter-frame spacing (IFS). As a result, the next CAN message can only be transmitted after at least 11 recessive bits.

FIG. 2 depicts an example state diagram 200 for CAN error handling. As shown, the state diagram 200 of FIG. 2 includes an error-active state 202, an error-passive state 204, and a bus-off state 206.

For example, CAN communication follows specific error-handling rules. There are five CAN error types: (i) bit monitoring, (ii) bit stuffing, (iii) frame check, (iv) acknowledgment check, and (v) cyclic redundancy check. The present disclosure focuses on bit monitoring and bit stuffing. A bit monitoring error occurs if the bit read on the CAN bus by an ECU is different from the bit level that it has written. No bit errors can be raised during the arbitration process. A bit stuffing error is caused by six consecutive bits of the same level (e.g., six consecutive bits of 0 or six consecutive bits of 1). According to the CAN protocol specification, when five consecutive bits of the same level have been transmitted by a node (e.g., an ECU), it will pad a sixth bit of the opposite level to the outgoing bit stream. The receiving ECUs will remove this sixth bit before passing it to the application.

Each ECU on the CAN bus has a transmit error counter (TEC) and a receive error counter (REC). The present disclosure focuses on mainly on transmission errors. A transmission error occurs when a transmitting ECU observes an error frame sent by a different ECU during its transmission of a CAN message on the bus. In such a case, a CAN-compliant node will do one of two things depending on the current value of its TEC. For example, each ECU starts in its error-active state 202. When the TEC is between 0 and 127 (in the error-active state 202), the node that detects the error will transmit an active error flag consisting of six dominant (logical 0) bits followed by 8 recessive (logical 1) bits as an indication to all other nodes that the transmitted frame had an error and should be ignored. If the node's TEC is in the error-passive state 204 (when the TEC exceeds 127), the node will transmit a passive error flag consisting of fourteen recessive bits. Note that the passive error flag does not destroy other bus traffic, and hence the other nodes will not hear “complaint” about bus errors. In both cases, the node will increment its TEC by 8 and then retransmit the message. The minimum separation between the original transmission and retransmission are 11 recessive bits (e.g., 8 bits from the error flag plus 3 bits from IFS) in the error-active state 204, and 25 recessive bits (e.g., 14 bits from the error flag plus 3 bits from IFS plus 8 bits from additional transmission suspension) in the error-passive state 204. When the TEC reaches 256, the node enters the bus-off state (or mode) 206 and will no longer participate in CAN traffic activities. According to the CAN protocol, an ECU (or node) in its bus-off state 206 is allowed to recover into the error-active state 202 after observing at least 128 instances of 11 recessive bits on the CAN bus.

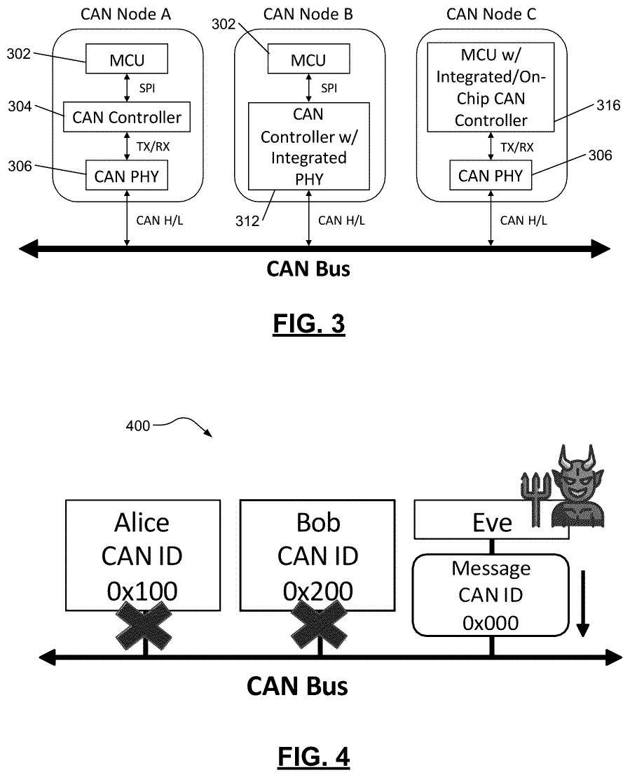

FIG. 3 depicts an example overview of an evolution of CAN hardware in ECUs. Each ECU (e.g., CAN node) is usually composed of three main components: a microcontroller unit (MCU), a CAN controller, and a CAN transceiver. The MCU executes the application whereas the latter two are integral components of CAN bus communication. However, the CAN controller and the CAN transceiver may have different responsibilities as they are located in different layers of the open systems interconnection (OSI) stack.

For example, CAN controllers operate on the data link layer and take certain information about a CAN message (e.g., CAN ID, DLC, Data) from the application in the MCU and build a complete CAN frame (effectively a digital bitstream) as described above relative to FIG. 1. Each CAN controller has two interfaces to the lower physical layer, namely CAN_TX and CAN_RX. Outbound data that will be sent on the CAN bus will be written to CAN_TX and inbound data that is read from the CAN bus will be on CAN_RX. Furthermore, the CAN controller implements the core logic of the CAN protocol such as error handling. It is also responsible for adding and removing stuff bits.

CAN transceivers, also known as CAN PHYs, operate on the physical layer. They are responsible for translating digital bitstreams from CAN_TX to an analog voltage (in the 0-5V range) and generating a bitstream from the analog voltage for CAN_RX. CAN uses differential voltage signaling using two levels CAN_H and CAN_L.

The internal design of CAN nodes had been gradually changing over time, as shown in FIG. 3. For example, CAN node A of FIG. 3 is a representation of an early CAN node. As shown, the CAN node A includes an MCU 302, a CAN controller 304, and a CAN transceiver (CAN PHY) 306 each as separate chips. In such examples, the MCU 302 would send and receive CAN frames from the CAN controller 304 via a serial peripheral interface (SPI) protocol.

CAN node B of FIG. 3 is a slightly modified version of the CAN node A. For example, and as shown in FIG. 3, the CAN node B includes the MCU 302 and a CAN controller and CAN transceiver combined in a single chip 312.

CAN node C of FIG. 3 represents a more recent version of ECUs. For example, and as shown in FIG. 3, the CAN node C includes an MCU 316 with an integrated/on-chip CAN controller, and the CAN transceiver (CAN PHY) 306. In such examples, the integrated/on-chip CAN controller is embedded in the MCU 316 and allows memory-mapped access to CAN bus functions. In many MCUs, such as the MCU 316, this involves access to interpreted CAN data, configuration of filters, and access to interrupts on arrival of new messages. Further, such MCUs allow the user to multiplex pins within the hardware at run-time, e.g., allowing the application software to directly read and write each bit of the CAN_RX and CAN_TX lines. In contrast, in the CAN nodes A, B, the application can only pass certain CAN message fields, such as CAN ID, DLC and data to the CAN controller which would be responsible for generating a complete CAN frame. The application could also only process the data from an incoming CAN message after successful receipt of the entire frame.

Due to the CAN's lack of security support, its attack landscape is wide and extensive. For example, an attacker can either have physical access to the CAN bus (e.g., through an on-board diagnostics (OBD) port inside the vehicle) or remotely compromise an ECU (e.g., an infotainment ECU which has wireless connections to the outside). Although physical access to the vehicle may seem to be an infeasible attack vector, remote attacks can also be mounted by exploiting vulnerabilities in wireless OBD dongles. Many commercial OBD dongles feature WiFi or cellular capabilities which open a new over-the-air attack surface. For example, a one-time physical access to the vehicle (e.g., by a malicious valet) can be sufficient to gain remote connection to the CAN bus.

Different possible CAN injection attacks exist including, for example, fabrication attacks, suspension attacks, and masquerading attacks. For example, fabrication attacks allow an adversary to fabricate and inject CAN messages with a legitimate CAN ID, but with arbitrary data. Since there is not any means of authenticating messages on CAN, other ECUs on the CAN will not know if the source of a message is legitimate or not. This is the weakest form of CAN injection attack and can be considered a basic spoofing attack. In case the attacker attaches their attacking node to the CAN bus (instead of remotely compromising a legitimate ECU), the legitimate ECUs will keep transmitting, and the adversary needs to transmit fabricated CAN messages at a higher frequency to override the data of CAN messages from legitimate ECUs. This adversary may be referred to as an external attacker.

If an ECU has been compromised remotely, the attacker has full control over that ECU and can transmit a CAN message with the original/genuine CAN ID, but with malicious payload. This adversary is referred to as an internal attacker. Although shown to work, remote ECU compromises require significant effort to achieve CAN bus access and cannot be thwarted by current state-of-the-art defenses. Technically, there is no possible way to distinguish a compromised ECU from a legitimate one by purely monitoring the CAN bus. Good security practices, such as ECU hardening and network segmentation on the gateway, should be followed to make remote compromises more difficult.

Suspension attacks on the victim ECU prevent the transmission of legitimate CAN messages by “silencing” the victim and are effectively DoS attacks. Typically, there are three types of DOS attacks on CAN bus: traditional, random, and targeted attacks. Traditional DOS attacks use the lowest possible priority CAN IDs (0x0) to always win arbitration and silence all ECUs on the CAN bus. Random DOS attacks send messages with random CAN IDs ranging from 0x0 to the highest legitimate CAN ID in the IVN. Targeted DOS attacks only send messages with a targeted CAN ID. Random and targeted DOS attacks are very similar by silencing only a subset of ECUs since CAN messages with lower message IDs will still be able to win arbitration.

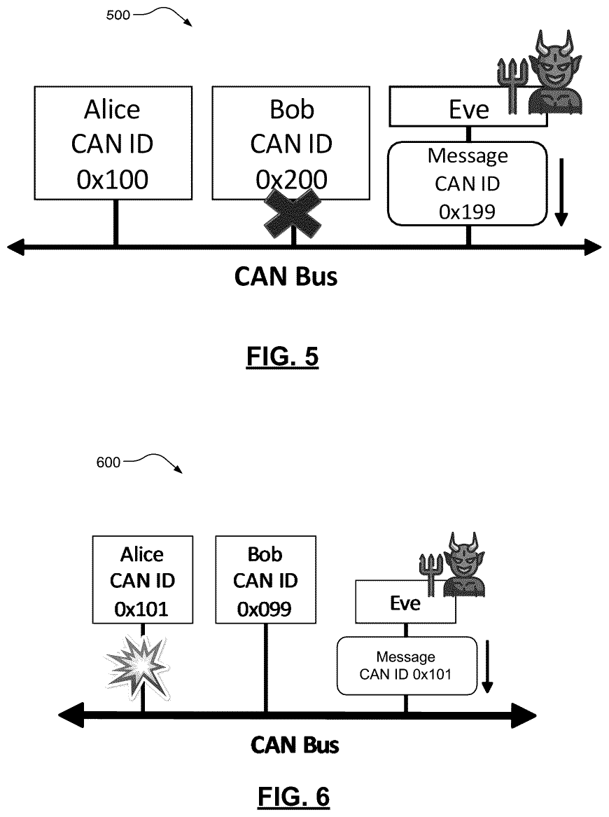

FIGS. 4 and 5 depict example diagrams 400, 500 of traditional and targeted DOS attacks. For example, in FIG. 4, a traditional DOS attack consists of an attacking ECU (or node) shown as “Eve” using the lowest possible priority CAN IDs (0x0) in a transmitted message to the CAN bus to always win arbitration and silence all other ECUs in the IVN, such as an ECU (“Alice”) having a CAN ID of 0x100 and another ECU (“Bob”) having a CAN ID of 0x200.

A targeted DOS attack is depicted in FIG. 5. As shown, the targeted DOS attack 500 consists of the attacking ECU shown as “Eve” using the priority CAN IDs (0x199) in a transmitted message to the CAN bus. In such examples, the attacking ECU (“Eve”) will win arbitration and silence the ECU (“Bob”) having the CAN ID of 0x200 but not the ECU (“Alice”) having the CAN ID of 0x100. As such, in this example, the ECU (“Bob”) is considered the targeted ECU.

Masquerade attacks combine both of the above types of attacks by first suspending a legitimate ECU's CAN broadcast and then fabricating its data field. Such attacks demonstrate why preventing DOS attacks is of utmost importance for a secure CAN bus.

The solutions herein can both detect and prevent spoofing attacks (e.g., in the case of an external attacker) as well as DOS attacks (for both internal and external attackers). As a result, the solutions (MichiCAN) provide protection against all types of feasible CAN injection attacks. In such scenarios, it is assumed that the adversary (e.g., attacking ECU) follows the CAN protocol which is a necessary pre-requisite for any countermeasure to work. For instance, an attacker that does not adhere to the CAN error-handling mechanism can never be confined to the bus-off state.

As further explained below, MichiCAN may operate in five phases: (a) an initial configuration phase; (b) a synchronization phase; (c) a detection phase; (d) a pin multiplexing phase; and (e) a prevention phase. The initial configuration phase is done offline and only once by the OEM at the time of vehicle manufacturing. The synchronization and detection phases are performed for each received CAN message, whereas the pin multiplexing and prevention phases are engaged only if an incoming CAN message is identified as malicious (e.g., a spoofing or DOS attack).

During the initial configuration phase, MichiCAN is implemented on every ECU on the IVN. For example, suppose there are N ECUs on the IVN, all of which are equipped with integrated CAN controllers as described above relative to the CAN node C of FIG. 3. In such examples, an ordered list of all ECUs may be defined as E={ECU₁, . . . , ECU_{N}}. Without loss of generality, assuming that each ECU transmits one unique CAN ID, ECUᵢ of the set E is equal to its CAN ID. As restrictive as this may sound, MichiCAN also generalizes to ECUs transmitting more than one CAN ID, as long as messages with the same CAN IDs are not transmitted by any other node—which has been followed in all production vehicles. For an easier understanding, the following description will stick to the above assumption and nomenclature. As such, in this ordered list of ECUs, ECU₁ would have the lowest CAN ID and thus the highest priority, whereas ECU_{N} has the highest CAN ID and the lowest priority.

Each ECUᵢ of the set E may detect a spoofing attack if it observes a CAN message with CAN ID ECU_{A} (injected by the adversary) that is equal to its own CAN ID. As such a definition of a spoofing attack may be depicted as ECUᵢ=ECU_{A} and stored in every ECU on the IVN during the initial configuration phase.

FIG. 6 depicts an example diagram 600 of such an attack. As shown, the attacking ECU (“Eve”) uses a CAN ID of 0x101 in a transmitted CAN message to the CAN bus. The ECU (“Alice”) having the same CAN ID of 0x101 observes the CAN message and detects the spoofing attack implemented by the attacking ECU (“Eve”).

Additionally, each ECUᵢ of the set E may detect a DOS attack if it observes a message with a lower CAN ID ECU_{A} than its own ID that does not originate from any other legitimate ECU in the set E. A definition of a DOS attack may be depicted as shown below and stored in every ECUᵢ on the IVN during the initial configuration phase.

$${ECU}_{A} < {ECU}_{i} , E C {U}_{A} ∈ E ∖ E C {U}_{j} ∀ j ∈ [ 1 , N ] ∧ i \neq j$$

For instance, if there are N=2 ECUs in the IVN with E={0x005, 0x00F}, the ECU transmitting CAN ID 0x00F will detect all CAN IDs between 0x000 to 0x004 and 0x006 to 0x00F (including its own which would be a spoofing attack) as malicious. It cannot make a detection decision for CAN ID 0x005 since it can be a legitimate transmission from the other ECU. Only the ECU transmitting CAN ID 0x005 can decide whether a message on the CAN bus with its own ID is legitimate or not.

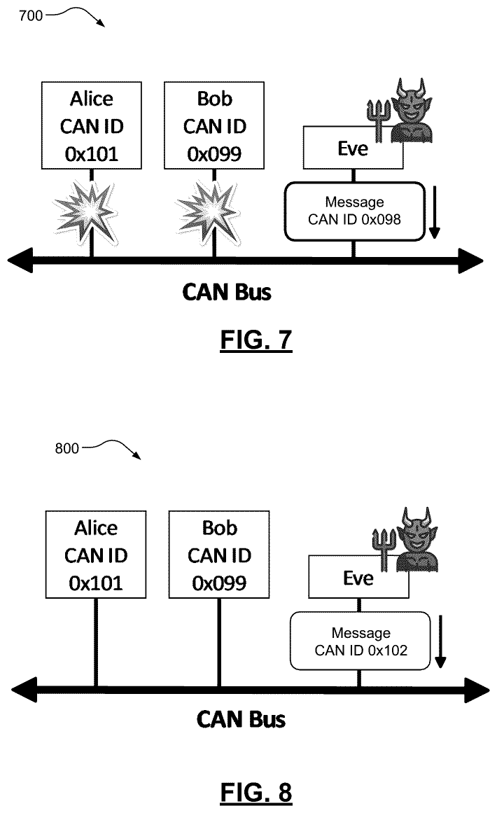

FIG. 7 depicts an example diagram 700 of a DOS attack. As shown, the attacking ECU (“Eve”) uses a CAN ID of 0x098 in a transmitted CAN message to the CAN bus. The ECU (“Alice”) and the ECU (“Bob”) having the CAN IDs 0x101 and 0x099, respectively, both observe the CAN message and detect the DOS attack implemented by the attacking ECU (“Eve”). For example, the ECU (“Alice”) will detect all CAN IDs between 0x000 to 0x098 and 0x0100 to 0x101 and the ECU (“Bob”) will detect all CAN IDs between 0x000 to 0x100.

Additionally, an attacker may inject a message with CAN ID ECU_{A} higher than ECU_{N} which is equal to the highest CAN ID in the IVN. This is called a miscellaneous attack. A definition of a miscellaneous attack may be depicted as ECU_{A}>ECU_{N} and stored in every ECU on the IVN during the initial configuration phase.

FIG. 8 depicts an example diagram 800 of a miscellaneous attack. As shown, the ECU (“Eve”) uses a CAN ID of 0x102 in a transmitted CAN message to the CAN bus. The ECU (“Alice”) has the CAN ID 0x101 and the ECU (“Bob”) has the CAN ID of 0x099.

If the attacker ECU (“Eve”) injects the message at the same time as another ECU, such as the ECU (“Alice”) or the ECU (“Bob”), it will lose arbitration. However, if the message is injected during a bus idle state, e.g., when there are no other CAN messages transmitted on the bus, the attacker will naturally win arbitration and broadcast its message. Since no other ECUs know (or listen to) this CAN ID, there may not be immediate impact on the vehicle's operation. However, a higher-priority CAN message will need to wait until the attacker's message has completed transmission before sending its CAN message. Given that an average CAN frame consists of 125 bits, the blocking time at a 500 kBit/s bus speed is 250 μs. The higher-priority message which has been buffered by the legitimate ECU will then start its transmission after 11 recessive bits on the CAN bus. Even if the attacker ECU (“Eve”) repeats its attack and finds a suitable bus-idle time, the maximum blocking delay for the legitimate ECU (“Alice” or “Bob”) is much smaller than the deadline for safety-critical CAN messages which stands around 10 ms. As a result, miscellaneous attacks can never interfere with legitimate CAN communications and thus do not pose a serious threat to the CAN bus.

Additionally, each MichiCAN-equipped ECUᵢ of the set E needs to store a detection range D of CAN IDs that it needs to mark as malicious. A definition for determining the detection range D may be depicted as shown below and stored in every ECUᵢ on the IVN during the initial configuration phase.

$$D = \{ j \vert 0 \leq j \leq {ECU}_{i} ∧ j \neq EC {U}_{k} ∧ 0 \leq k < i \}$$

Since integrated CAN controllers in the ECUs allow direct read access to every bit of an incoming CAN frame C during its transmission, the detection range D can be encoded as a finite state machine (FSM). In effect, the FSM is a binary tree since each transition “input” can be either 0 or 1. The root of the tree is the start-of-frame (SOF) bit since the 11-bit CAN ID C=c₀∥ . . . ∥ c₁₀ will immediately follow that bit. The FSM is run for each bit individually and needs to traverse all 11 bits only in the worst case. If a decision can be made after the 11-th bit or earlier, it will terminate since C∈D (e.g., C is in the detection range D) and set the malicious flag to true. Alternatively, if C∉D (e.g., C is not in the detection range D), the FSM will set the flag to false.

This initial configuration phase is done offline only once by the OEM or Tier-1 suppliers during the development of a vehicle. The FSMs are generated in four stages as detailed below. Each generated FSM is unique for one particular ECUᵢ and will then be added to the corresponding ECU's source code. To better illustrate and explain the respective stages, consider an example with E={0x100, 0x101, 0x110, 0x150}. Table 1 below provides the CAN IDs' binary and decimal representations. As shown, each ECUᵢ of the set E has a binary 11-bit string. As used below, ECU_{i,j} is defined as i∈[1,N] and j∈[0,10] to address each respective bit of the CAN ID, while j=0 indicates the most significant bit (MSB).

TABLE 1
Example IVN Configuration

| ECUᵢ | Hex | Binary | Decimal |
|---|---|---|---|
| ECU₁ | 0x100 | 001 0000 0000 | 256 |
| ECU₂ | 0x101 | 001 0000 0001 | 257 |
| ECU₃ | 0x110 | 001 0001 0000 | 272 |
| ECU₄ | 0x150 | 001 0101 0000 | 336 |

Stage 1 corresponds to finding globally malicious bits. Theoretically, up to 2,048 CAN IDs can be encoded with an 11-bit ID. A typical size of the set E (e.g., used CAN IDs in an IVN) usually does not exceed 200. Over 1,800 CAN IDs (or 90% of the set E) remain unassigned. As a result, certain bits j in CAN IDs ECU_{i,j} of the set E may stay constant. Such bits are called j globally malicious (GM) since the opposite value at that specific bit position of an incoming CAN ID C (e.g., Cⱼ) would immediately indicate that C∈D. For each bit j, a variable GMⱼ is defined as shown below and set to true only if bit j is globally malicious.

$$G {M}_{j} = ¬ {⊕}_{i = 1}^{N} E C {U}_{i , j}$$

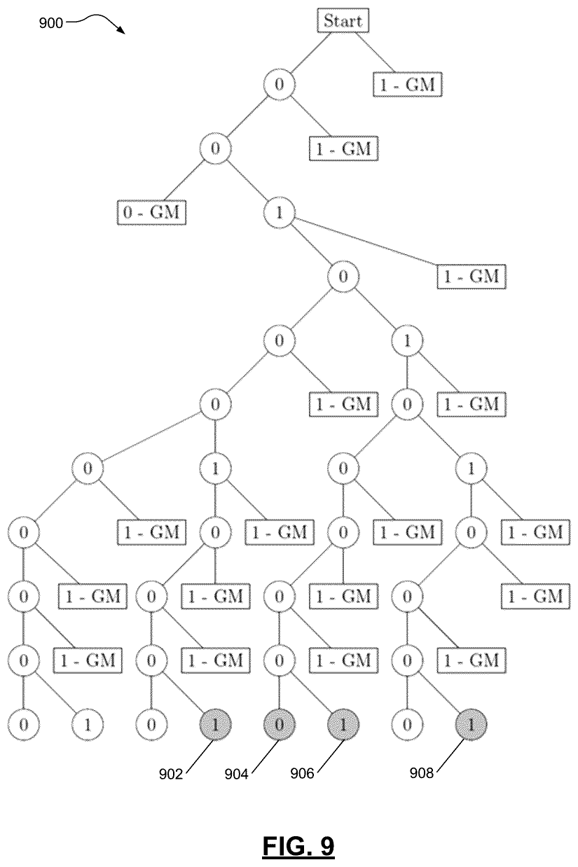

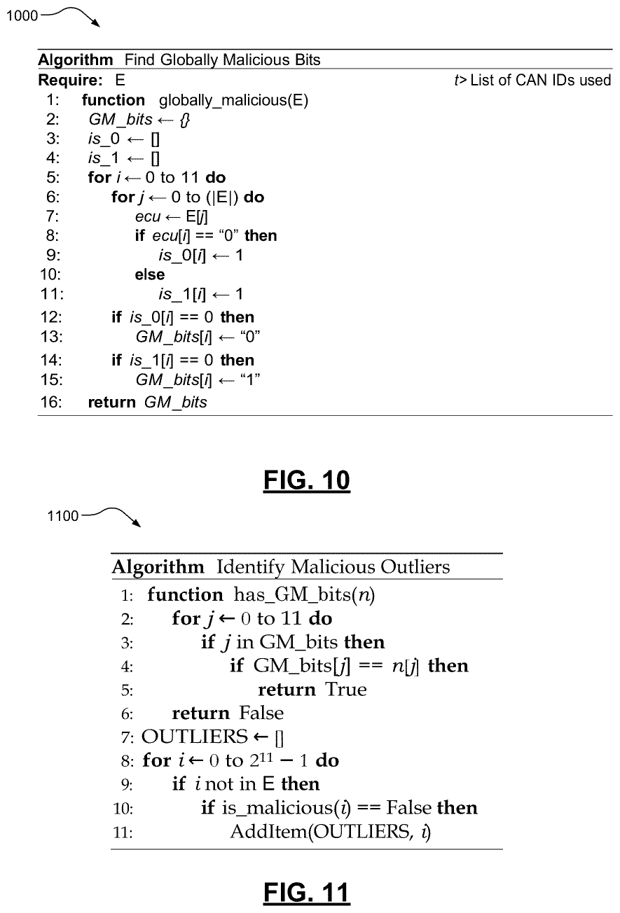

For the example of Table 1 above, GM₀=GM₁=GM₂=GM₃=GM₅=GM₇=GM₈=GM₉=1. FIG. 9 illustrates an example diagram of a binary tree 900 for this example where globally malicious bits are labeled as GM. The depth of the tree 900 of FIG. 9 for 11-bit CAN IDs is 11. Due to the small size of this example, there are several GM bits, but with a growing set |E|, the number of GM bits will drop, often to zero. Nevertheless, this stage is very efficient in terminating the FSM as early as possible in the presence of GM bits. This will reduce detection latency and CPU overhead on the ECU as it does not run the FSM for less significant bits. As shown in FIG. 9, all branches below a GM bit are pruned. The procedure for finding and marking GM (globally malicious) bits is shown and described in an example algorithm 1000 in FIG. 10.

Stage 2 corresponds to identifying malicious outliers. All 8 unpruned leaf nodes L∈L in FIG. 9 are potentially non-malicious CAN IDs. Since this example only has 4 legitimate CAN IDs ECUᵢ∈E ⊂L, the other 4 outliers O ∈L \E need to be removed in the next stage. In the example of FIG. 9, these outliers are indicated with reference numbers 902, 904, 906, 908, and correspond to four leaf nodes 0x111, 0x140, 0x141 and 0x151. In the next stage, local prefixes may be generated to remove these outliers. The procedure for identifying malicious outliers is shown and described in an example algorithm 1100 in FIG. 11.

Stage 3 corresponds to generating local prefixes for removing outliers. A straightforward and intuitive way to remove outliers is to parse all 11 bits of the CAN ID and set the malicious flag to true for them. In the above example, only 4 outliers are present. However, the number of outliers may be much larger in an IVN with more ECUs. Hence, the FSM would become very large and computationally heavy. It would also increase the detection latency since the entire CAN ID has to be parsed. If an outlier is guaranteed after p bits, the FSM may be terminated at that bit position and set the malicious flag to true. The bit sequence of the outlier's CAN ID up to that bit position p is called local prefix, and is denoted as Op=o₀∥ . . . ∥ oₚ. It is the minimum bit sequence that needs to be parsed to distinguish the outlier O from a truly non-malicious CAN ID ECUᵢ in the set E. The bit position p for an outlier O can be calculated by logically XORing the bit sequence of O with ECU₁. Bits that match will generate a 0 as the result of the XOR operation and the first bit that is different will yield a 1. At the first occurrence of 1, the outlier O can be distinguished from ECU₁. To account for the worst case, this process may be repeated with every ECUᵢ in the set E and the latest occurrence may be chosen as the minimum bit position p as depicted below.

$$P = 11 - {log}_{2} ( min ( {o}_{j} ⊕ E C {U}_{i , j} ) ) , ) ) , ∀ E C {U}_{i} ∈ E$$

In the example above, 0x111, 0x140, 0x141 and 0x151 are the outliers. Logically XORing the first outlier, 0x111 with every ECUᵢ in the set E shows that the largest bit sequence until a logic value 1 appears is with CAN ID 0x110. As a result, the local prefix for outlier 0x111 will be O¹¹=00100010001 and all p=11 bits need to be checked for setting the malicious flag to true. The same applies to outlier 0x151. For the other two outliers, both local prefixes evaluate to 0⁷=0010100 and a decision can be made early at p=7. The procedure for generating local prefixes is shown and described in an example algorithm 1200 in FIG. 12.

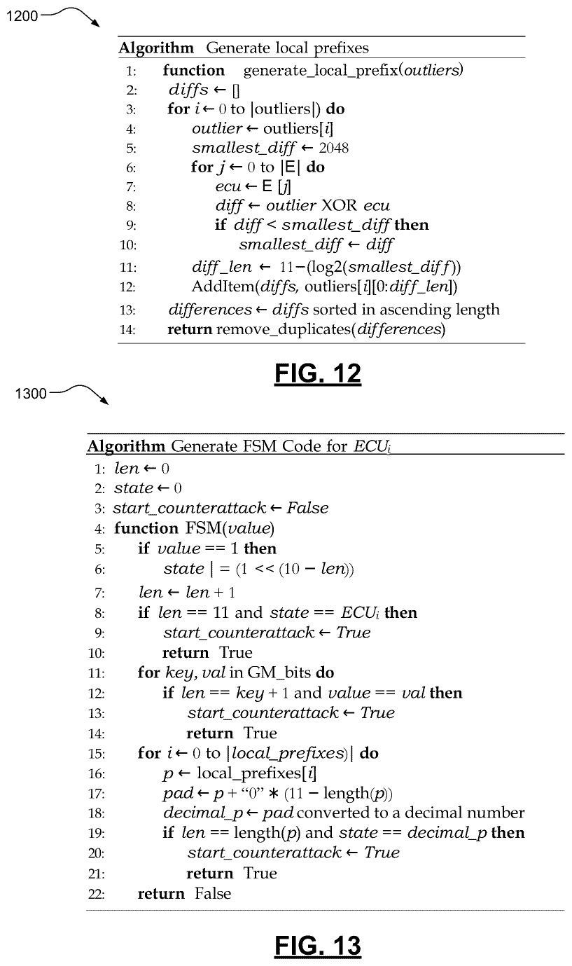

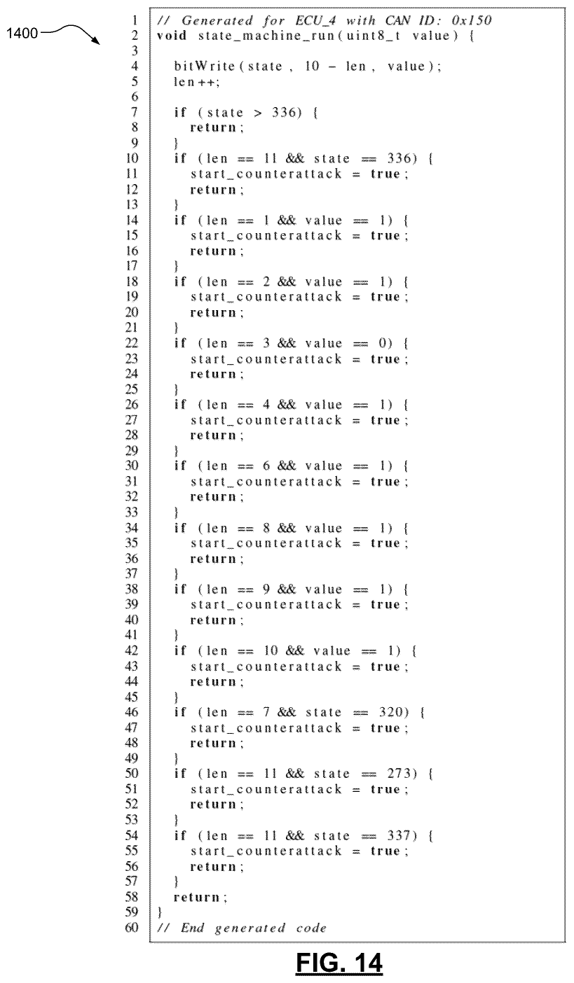

Stage 4 corresponds to generating FSM Code. In this stage, the GM bits and local prefixes from previous stages are used to generate the FSM. One example listing 1400 of C++ code for the example from Table 1 above is provided in FIG. 14. The code in FIG. 14 is specifically generated to be uploaded to ECU₄ with CAN ID 0x150 from the example of Table 1. As discussed before, miscellaneous attacks are ignored (e.g., see lines 7-9 of FIG. 14) and spoofing attacks are detected (e.g., see lines 10-13 of FIG. 14). Next, the logic from the previous stages is used to generate the if-statements for DOS attack detection. The first comparisons are made for GM bits (e.g., see lines 14-45 of FIG. 14) since they can cover a wide range of CAN IDs in the detection range. The last three if-statements cover local prefixes (e.g., see lines 46-57 of FIG. 14). The generated FSM code for another ECUᵢ in the set E only differs between lines 7-13 of FIG. 14. For example, the state value needs to be changed to the decimal representation of each respective ECUᵢ. The procedure for generating the FSM code is shown and described in an example algorithm 1300 in FIG. 13.

The generated FSM gets larger with the number of GM bits or local prefixes as more if-statements will be added to its code and thus increase its complexity. Analysis of the complexity of FSMs with different IVN sizes |E| is further described below. Since the complexity of the FSM will have an effect on the required CPU cycles, it is desirable to minimize the number of if-statements in the generated code. Currently, each ECUᵢ in the set E may detect both spoofing and DOS attacks. This enhances reliability and robustness since each ECUᵢ will detect a malicious transmission simultaneously. This is also beneficial in case legitimate ECUs fail. Even if |E|−1 ECUs fail (which is highly unlikely), one ECU can still detect the attack. Alternatively, if the IVN consists of a large number of ECUs, the set E may be equally split into two subsets E₁ and E₂ of size |E|/2 each, with the former subset containing the lower half of CAN IDs and the latter the upper half. E₂ may run the above-described procedure. In contrast, E₁ may only detect spoofing attacks (on their own respective CAN IDs). The FSM code can be truncated to lines 1-13 of FIG. 13 in this case. The advantage of this approach is that the lower half of CAN IDs (which are higher-priority and usually more safety-critical) will execute the FSM very fast which incurs lower computational overhead to those ECUs. Nevertheless, the network will still be protected from DOS attacks since all ECUs in E2 will still run the DoS protection routine. This configuration may be referred to as a light scenario, whereas every ECU running the original FSM (including spoofing and DoS protection) may be referred to as a full scenario.

Next, the pin multiplexing phase of MichiCAN is described. As mentioned above, pin multiplexing is engaged only if an incoming CAN message is identified as malicious (e.g., a spoofing or DOS attack).

For example, as mentioned above with respect to the CAN node C of FIG. 3, modern ECUs/MCUs are equipped with an integrated CAN controller. The CAN transceiver (also called CAN PHY) is a standalone chip that converts the analog CAN_H and CAN_L differential voltage to a digital bitstream (CAN_TX/CAN_RX), and vice versa. MCUs interface outside/peripheral components using their peripheral I/O (PIO) controller. Broadly speaking, there are two categories of PIO pins: system I/O (SIO) pins and general-purpose I/O (GPIO) pins. For instance, an ECU features SIO pins to connect to the CAN transceiver (CAN PHY). By default, these pins are usually only read by the CAN controller (a system component of the MCU package) since the application software does not need access to this low-level bitstream. The application can interact with peripheral I/O using its GPIO pins. Nevertheless, the PIO controllers of modern MCUs have multiplexing capabilities which allow a GPIO pin to be multiplexed to a SIO pin. As a result, the PIO controllers can be configured such that each ECU's application software has direct access to the CAN_TX/CAN_RX lines, which, in turn, allows the ECU to directly read (e.g., receive) and write every single bit of a CAN message on the CAN bus transmitted by other ECUs.

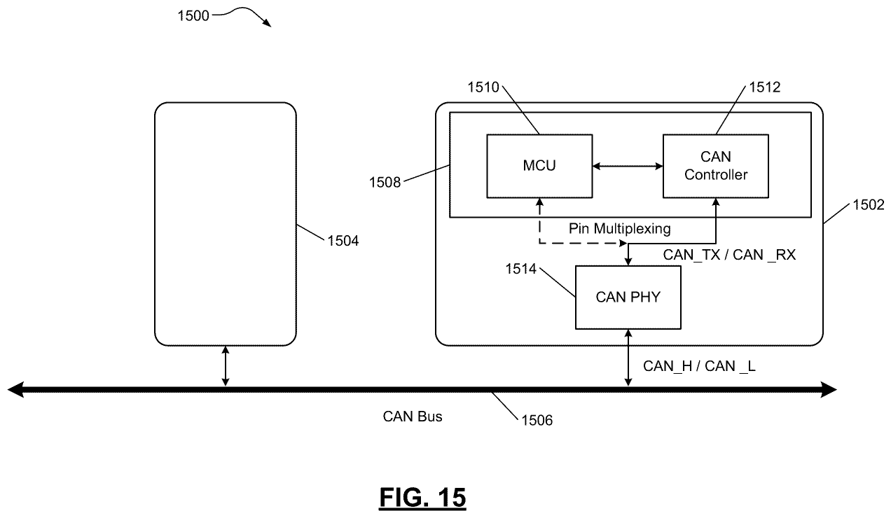

FIG. 15 depicts an example system 1500 employing pin multiplexing. As shown, the system 1500 includes two ECUs (or ECMs) 1502, 1504 each complying with a CAN protocol. The ECUs 1502, 1504 are in communication via a CAN bus 1506. In the example of FIG. 15, the ECUs 1502, 1504 are considered modern ECUs. For example, and as shown in FIG. 15, the ECU 1502 includes a chip 1508 having a MCU 1510 with an integrated CAN controller 1512, and a CAN transceiver (CAN PHY) 1514 in communication with the MCU 1510 and the CAN controller 1512. Although not shown in FIG. 15, the ECU 1504 includes similar components as the ECU 1502.

Pin multiplexing can be configured dynamically in software. In other words, configuring pin multiplexing can be done once at boot time or anytime while the MCU 1510 is running. MichiCAN requires read access to the CAN_RX line once booted up, but write access to CAN_TX only when it starts a counterattack. As such, the MCU 1510 may enable pin multiplexing in response to identifying a CAN message as malicious (as explained herein). After the counterattack has been completed, the MCU 1510 may disable (or deactivate) the multiplexing. Pulling the CAN bus 1506 low after the counterattack would destroy all traffic on the CAN bus 1506 and pulling it high would cause issues with non-malicious CAN messages, as each CAN controller has to acknowledge the receipt of a well-formed CAN message by writing a dominant bit to the ACK bit in the CAN trailer. If the CAN_TX pin multiplexing is still active, the MCU 1510 would have to continue sampling until the trailer (at the end of the CAN frame) and correctly insert a dominant bit at the correct bit time, unnecessarily increasing the computational cost.

In the example of FIG. 15, each of the arrowed lines depict connections to SIO pins in the ECU 1502 for connecting to the MCU 1510 and the CAN controller 1512 to the CAN transceiver 1514. The dashed arrowed line depicts multiplexing to GPIO pins when multiplexing is enabled.

Next, the synchronization phase of MichiCAN is described. As mentioned above, the synchronization phase is performed for each received CAN message. For example, with continued reference to FIG. 15, each of ECU 1502, 1504 on the CAN bus 1506 has its own clock and needs to be synchronized to sample the bus reliably and correctly. This is especially important during the arbitration phase when each ECU 1502, 1504 competes for transmission. A discrepancy between ECUs' clocks would result in errors which need to be avoided if possible. Since all ECUs operate on the same bus speed (e.g., 500 kBit/s), their nominal bit time is fixed (e.g., 2 μs). During that bit time, either a logical 0 or 1 will be observed by all ECUs on their CAN_RX pin. Due to bit transitions (e.g., from 1 to 0) and hardware imperfections, sampling the bit right at the beginning of the bit time might result in sampling a wrong logical value. To avoid this problem, CAN controllers (e.g., the CAN controller 1512 of FIG. 15) usually sample the bit at 70% within the nominal bit time. CAN controllers continuously re-synchronize due to oscillator/clock drifts. A hard synchronization is done at each start-of-frame (SOF) bit, e.g., when a transition from 1 to 0 occurs after at least 11 recessive bits during the idle bus.

MichiCAN has to replicate the synchronization process in software since the CAN controller is being circumvented in the examples provided. One example way of doing this is to trigger timer interrupts every bit time (e.g., 2 μs) and then read in the value from CAN_RX. However, there may be issues with this straightforward approach. For example, there is no guarantee that each bit will be sampled. Additionally, the interrupts may not be triggered at the same location within each bit time due to oscillator drift of the clocks that the timer interrupts use. To overcome this, an additional external interrupt is introduced by the MCU (e.g., the MCU 1510 of FIG. 15) that will be triggered at each SOF, indicated by a bit transition from a recessive bit (1) to a dominant bit (0) after at least 11 recessive bits. At this point, a main timer interrupt may be restarted to trigger at 70% of the nominal bit time, as explained above. For example, for a 500 kBit/s CAN bus, the timer interrupt would first activate after 1.4 μs. Since the FSM and some other counter variables at the beginning of each CAN frame (which takes a constant number of clock cycles) are reset, MichiCAN may account for this when the main timer interrupts are restarted. As a result, the external interrupt may be triggered at a constant delta (e.g., a fudge factor) less than 1.4 μs. This can be determined empirically since the required clock cycles (and thus execution time) for the fudge factor will always be constant. Since the current bit is the SOF is known (set to 0) as explained above, this bit can be skipped and the timer interrupts may be restarted for the first bit of the CAN ID. As such, when a main interrupt handler is executed for the first time (e.g., during the first bit of the CAN ID), the interrupt timer may be disabled and restarted to trigger every 2 μs since there will be no additional operations (such as resetting the FSM).

Next, the detection phase of MichiCAN is described. As mentioned above, the detection phase is performed for each received CAN message. For example, and with continued reference to FIG. 15, since the CAN_RX can be read directly by the ECU 1502 and the ECU 1502 (including the MCU 1510) is properly synchronized to the CAN bus 1506, a detection routine may commence to identify a CAN message as malicious based on the attack definitions explained above.

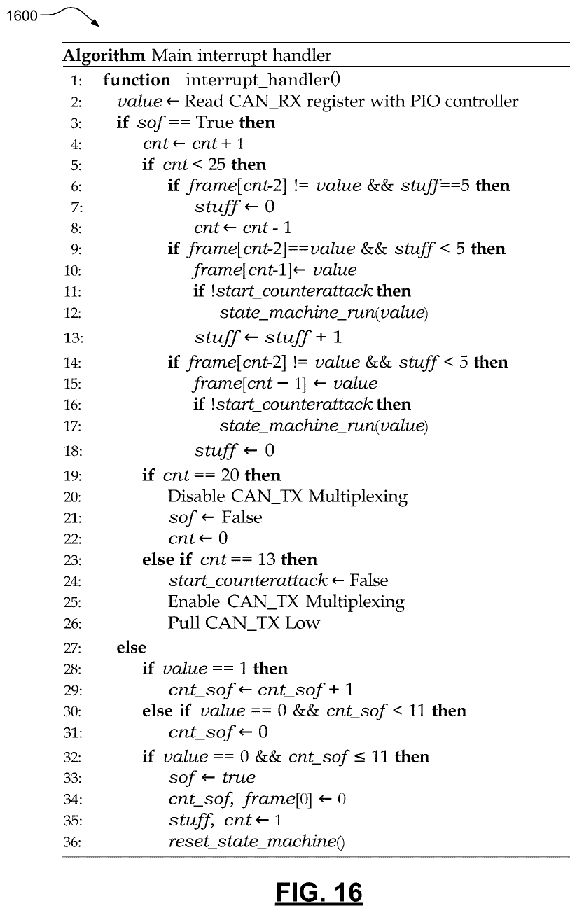

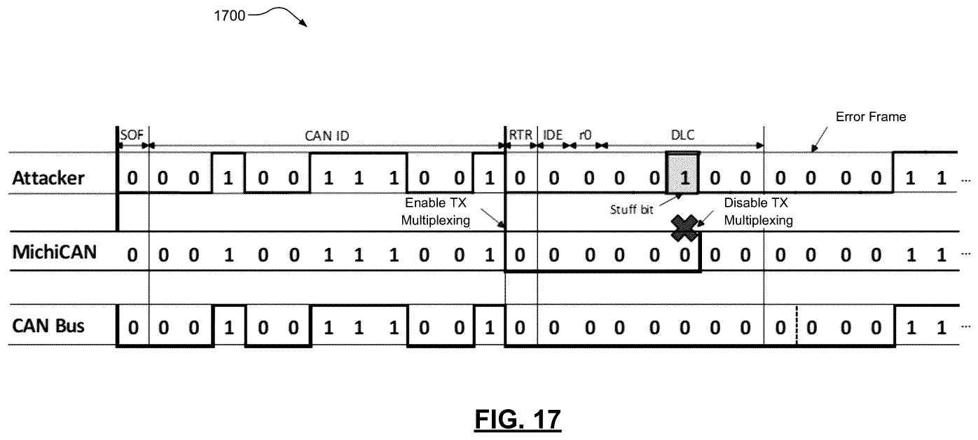

The procedure for identifying a CAN message as malicious is shown and described in an example algorithm 1600 in FIG. 16. For example, and explained above, the main interrupt handler will trigger for the first time at the first bit of the CAN ID. At the very beginning of the interrupt handler, the bit from CAN_RX is read. Since the PIO controller of the MCU 1510 of FIG. 15 is used for pin multiplexing, the value of CAN_RX from the MCU's registers can be directly read, as shown in line 2 of the algorithm 1600. This avoids using an external read function from the MCU's libraries which would add unnecessary computational overhead.

Then, a counter (e.g., in the MCU 1510) is incremented to keep track at which bit position within a CAN frame MichiCAN is located. Since the interrupt is triggered every bit time, each execution of the interrupt handler will correspond to a new bit in the frame. As mentioned above, CAN_RX will contain stuff bits which are automatically inserted by a CAN controller (e.g., of the MCU 1504) if there are more than 5 bits of the same polarity. As a result, the stuff bits are detected and identified, as shown in lines 6-18 of the algorithm 1600. While reading the 11-bit CAN ID, MichiCAN needs to remove the stiff bits before appending them to a frame array. For each bit (that is not a stuff bit), MichiCAN runs the FSM as described above. Once the FSM determines that the CAN ID indicates a spoofing or DOS attack, a malicious flag start_counterattack will be set to true. To reduce computational overhead, MichiCAN will then stop running the FSM for the remaining bits of the CAN ID (e.g., lines 11-12 and 16-17 of the algorithm 1600) and just continue monitoring stuff bits.

Next, the prevention phase of MichiCAN is described. As mentioned above, the prevention phase is performed only if an incoming CAN message is identified as malicious (e.g., a spoofing or DOS attack). For example, once the start_counterattack flag has been raised as explained above (e.g., indicating a CAN message has been identified as malicious), the prevention routine may commence to eradicate the attacker ECU. The basic idea behind attack prevention is to launch a counterattack and bus off the attacker ECU according to CAN error-handling rules as explained above. This can be accomplished by causing an error in the adversary's transmission.

For example, the two error types that may be exploited are bit and stuff errors which can be achieved by transmitting a sequence of dominant bus levels. Note that a complete CAN message is not being sent. Instead, the solutions herein pull the CAN bus (e.g., the CAN bus 1506) low for a period of time by transmitting dominant bus levels. Since dominant bus levels always overwrite recessive ones, a recessive bit transmission by the adversary will result in a bit error. Alternatively, if the attacker ECU transmitted 5 consecutive dominant bits, it will be followed by a recessive stuff bit. Since the CAN bus is pulled low by transmitting dominant bus levels, the stuff bit will be overwritten by another dominant bit (e.g., from the MCU 1510 of FIG. 15) which results in a stuff error. FIG. 17 depicts an example prevention routine 1700 showing a stuff bit of the attacker's CAN message being overwritten by another dominant bit (0), thereby resulting in a stuff error.

With respect to the prevention routine 1700, the solutions herein may need to determine when to start injecting a dominant bit sequence, and how many dominant bits to inject. For example, although the detection routine (explained above) can terminate before the end of the CAN ID field, dominant bits cannot be injected during arbitration. This would lead to the attacker losing arbitration, but not generating an error frame. Since the goal is to bus off the attacker, it is desirable to inject the first dominant bit (e.g., from the MCU 1510 of FIG. 15) as soon as possible after the CAN ID field, e.g., during the RTR bit (see FIG. 1). However, since the RTR bit and the following IDE and r0 bits (see FIG. 1) are already dominant, no bit error will be generated. Additionally, the following DLC field (see FIG. 1) is usually encoded as “1000” (since CAN messages mostly consist of 8 data bytes), so the earliest bit error can be caused at the fourth bit. Therefore, the minimum duration that the CAN bus is pulled low to cause a bit error is four bits.

However, if the least-significant bits (LSB) of the CAN ID consist of consecutive dominant levels, a stuff error can be caused as early as in the RTR bit. For this to happen, the five LSBs of the CAN ID need to be dominant. In such scenarios, it may be sufficient to transmit one dominant bit during the RTR slot to raise an error frame. In the worst case, if the CAN data field (see FIG. 1) consists of only one byte (indicated by DLC bit string “0001”), causing a stuff error will require to inject 6 dominant bits if the LSB of the CAN ID is recessive.

As such, an error frame can be caused by injecting 1 to 6 dominant bits. Since this will depend on several factors (such as the DLC length) that are unpredictable during sampling the CAN frame, 6 dominant bits should be injected. The worst-case scenario (e.g., the DLC bit string is “0001”) is depicted in FIG. 17.

Additionally, and as explained above, the CAN_TX pin is disabled by default. At frame position 13 (e.g., 1 SOF plus 11 CAN ID plus1 RTR), multiplexing of the CAN_TX is enabled to pull the pin low and set the start_counterattack flag to false (e.g., see lines 23-26 of the algorithm 1600 in FIG. 16). At frame position 18 of the prevention routine 1700 in FIG. 17, the stuff bit (1) of the attacker's CAN message is overwritten by a dominant bit (0) which results in a stuff error. At frame position 18 or after (e.g., at frame position 20), CAN_TX multiplexing is disabled which will automatically stop pulling the CAN bus low, the start-of-frame flag is set to false, and the frame counter is set to 0 as processing of the frame is completed, as shown in lines 19-22 of the algorithm 1600 in FIG. 16.

As a result of the injection of the dominant bit (0) at frame position 18, the attacker (who has to comply with the CAN protocol) will immediately raise an active error frame consisting of six dominant bits followed by eight recessive bits, as partly shown in the prevention routine 1700 in FIG. 17. Even if only one dominant bit is transmitted (e.g., injected) in the best-case scenario (e.g., during the RTR slot as explained above), five additional dominant bits will not do any harm due to the six-bit dominant error flag.

As a result of the active error frame, the transmission error counter (TEC) of the attacking ECU increases by 8 as explained above. The attacking ECU will then attempt a retransmission after a total of 11 recessive bits (see, e.g., lines 27-36 of the algorithm 1600 in FIG. 16). At the SOF bit, several variables, as well as the FSM will be reset. At this time, the detection procedure may be repeated again to identify the retransmitted CAN message as malicious, and the prevention procedure will commence (again) to begin another counterattack. After a total of 15 retransmissions, the attacking ECU will transition into its error-passive region and start transmitting passive error frames. After another 16 retransmissions (summing up to a total of 32 attempts), the attacking ECU will be confined into a bus-off state.

In the examples above, it is assumed that the retransmissions from the attacking ECU are not disturbed by any other CAN messages (e.g., from legitimate ECUs, another attacking ECU, etc.) on the CAN bus. Since any ECU can transmit after an idle period of 11 recessive bits (which is the minimum between retransmissions as well), a CAN message with a lower CAN ID would win arbitration and thus interrupt the repeated transmissions from the attacking ECU. This will come at the expense of increasing the bus-off time. However, since each CAN ID of a frame is compared (as explained above), even for a retransmission, the attacking ECU will eventually be eradicated (e.g., confined into a bus-off state) as expected, even in the presence of multiple concurrent attackers.

By employing the solutions herein, incoming DoS and/or spoofing attacks from an attacking ECU in an IVN may be detected with a 100% detection rate and then the attacking ECU eradicated by busing off the attacking ECU in the least possible time under the CAN protocol while minimizing computing resources (e.g., CPU usage, etc.). Specifically, the solutions herein enable the detection and prevention of DoS and/or spoofing attacks in real time (e.g., at the first instance/message of the attack), while providing backward compatibility (e.g., based on software) for use in new and existing ECUs.

For example, the total time from the first bit of a malicious CAN message to the last bit of the passive error frame in the 31st retransmission is called the bus-off time. The bus-off time depends on the attacker's CAN ID since in the best-case scenario, only one dominant bit is injected (e.g., during the RTR slot as explained above), whereas in the worst-case scenario, 6 dominant bits are injected (as explained above relative to FIG. 17) to trigger an error frame. Table 2 below shows error-active and error-passive transmission times, and the entire bus-off time for the best-case (BC) and worst-case (WC) scenarios at bus speeds of 50 and 125 kbit/s when an attacking ECU is not interrupted during its repeated transmissions. Testing has shown that a WC bus-off time of 10 ms for a 125 kbit/s bus, as shown in Table 2. Using a higher-speed bus running at 500 kbit/s, the WC time will decrease to 2.5 ms.

TABLE 2
Buss-Off Time For One Attacker ECU

| Bus Speed | | Error-Active | Error-Passive | Bus-off |
|---|---|---|---|---|
| (kbit/s) | Scenario | Time (μs) | Time (μs) | Time (ms) |
| 50 | BC | 600 | 760 | 21.8 |
| | WC | 700 | 860 | 25.0 |
| 125 | BC | 240 | 304 | 8.7 |
| | WC | 280 | 344 | 10.0 |

Additionally, because MCUs may employing the solutions herein incur computational overhead, it is important to measure the impact on CPU utilization. As the solutions may be employed as a software patch to existing application software running on MCUs, minimal overhead is desired. For example, CPU utilization may be evaluated for both full and light scenarios of the FSM, as explained above.

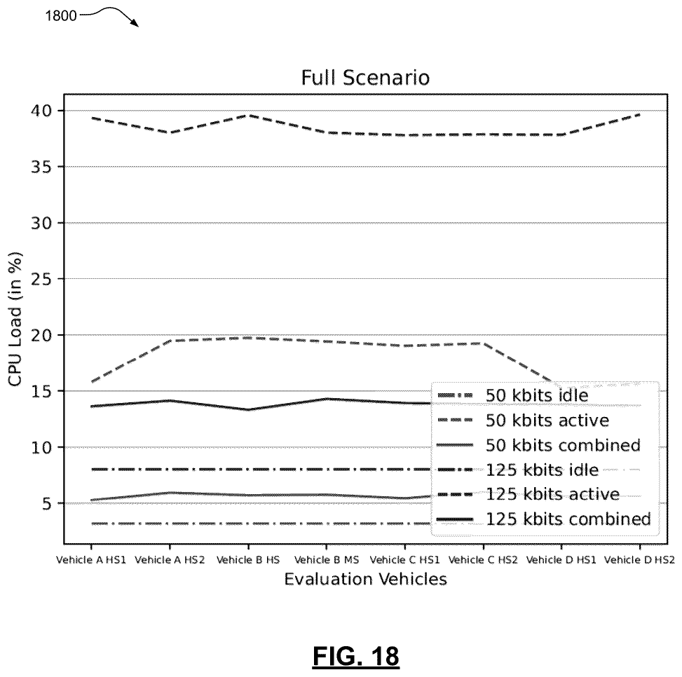

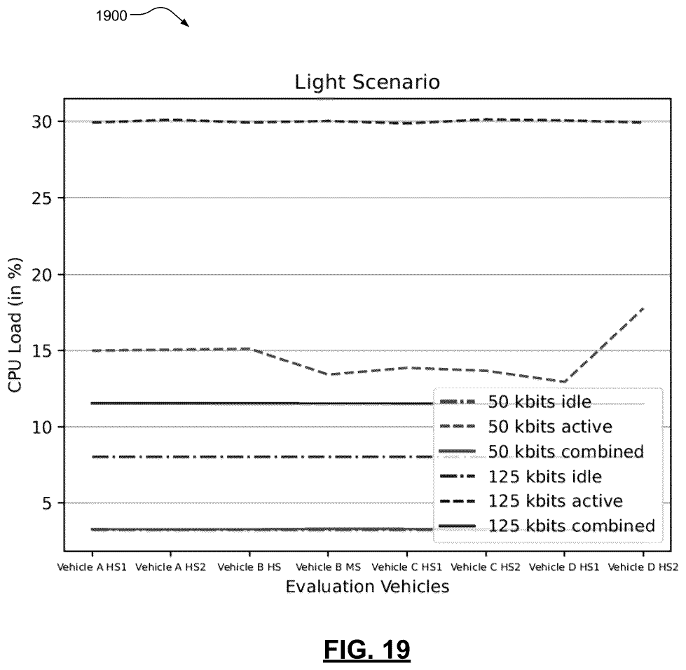

FIGS. 18-19 depict graphs 1800, 1900 showing CPU loads with respect to different vehicles for full and light scenarios, respectively. Specifically, the graphs 1800, 1900 show the mean idle, mean active and combined CPU loads for both the full and light scenario, respectively, for four different production vehicles. The mean idle CPU loads are depicted with dash-dot-dash lines at bus speeds of 50 and 125 kbit/s, the mean active idle CPU loads are depicted with dash-dash lines at bus speeds of 50 and 125 kbit/s, and the combined idle CPU loads are depicted with solid lines at bus speeds of 50 and 125 kbit/s. The mean idle CPU loads represent CPU utilization during a period when no CAN messages are on the bus (e.g., a bus-idle state). The mean active idle CPU loads represent CPU utilization during another period when a CAN frame is processed, and the combined idle CPU loads represent both periods and thus describes the average CPU utilization overhead. While the mean active load for 125 kbit/s in the full scenario hovers around 40% in FIG. 18, the light scenario consumes less computation power at 30% utilization, as shown in FIG. 19. This amounts to a 25% reduction in CPU cycles.

Although the embodiments herein are described with respect to controller area network (CAN) protocols, messages, buses, etc., it should be appreciated that the teachings herein may be applicable and/or implemented with respect to any suitable serial data link protocol associated with a vehicle network in which serial messages are communicated between, for example, ECUs.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware. In various implementations, the functionality of the module may be distributed among multiple modules that are connected via the communications system.

Additionally, the term code may include software, firmware, and/or microcode, and may refer to computer programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

The techniques described herein may be implemented by, for example, one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “descrambling” or “scrambling” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a computer selectively activated or reconfigured by a computer program stored on a tangible computer readable medium that can be accessed by the computer.

The algorithms and operations presented herein are not inherently related to any particular computer or other apparatus. Various systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

What is claimed is:

1. A system for detecting and preventing, in real time, malicious broadcasting messages from an electronic control module attempting to attack a vehicle network, the system comprising:
a plurality of electronic control modules in communication via a serial data link of the vehicle network, at least a first electronic control module of the plurality of electronic control modules configured to:
receive at least a portion of a serial message on the vehicle network transmitted by a second electronic control module of the plurality of electronic control modules;
identify the serial message from the second electronic control module as malicious based on the received portion of the serial message; and
in response to identifying the serial message as malicious, inject a dominant bit into the serial message for the vehicle network to cause an error frame in the serial message transmitted by the second electronic control module.

2. The system of claim 1, wherein the first electronic control module is configured to identify the serial message from the second electronic control module as malicious based on a unique message identifier (ID) of the serial message.

3. The system of claim 1, wherein the dominant bit has a value of zero.

4. The system of claim 1, wherein the serial data link is a controller area network (CAN) protocol and wherein the plurality of electronic control modules are configured to comply with the CAN protocol.

5. The system of claim 4, wherein:
the serial message on the vehicle network transmitted by the second electronic control module is a first CAN message; and
the first electronic control module is configured to receive a portion of a plurality of second CAN messages on the vehicle network transmitted by the second electronic control module, identify each of the second CAN messages from the second electronic control module as malicious based on the received portion of each second CAN message, and in response to identifying the CAN message as malicious, inject a dominant bit into each second CAN message for the vehicle network to cause an error frame in each second CAN message transmitted by the second electronic control module and force the second electronic control module into a bus-off state.

6. The system of claim 4, wherein:
the first electronic control module includes a microcontroller unit (MCU) with an integrated CAN controller, and a CAN transceiver; and
the MCU is configured to inject, via the CAN transceiver, the dominant bit into the serial message for the vehicle network, thereby bypassing the integrated CAN controller.

7. The system of claim 6, wherein the MCU is configured to trigger an interrupt at a start of frame field of the serial message indicated by a bit transition from a recessive bit to a dominant bit during the start of frame field, and then trigger a subsequent main timer interrupt to synchronize the MCU of the first electronic control module with the second electronic control module.

8. The system of claim 7, wherein the MCU is configured to trigger the subsequent main timer interrupt at seventy percent of the nominal bit time of the serial message.

9. The system of claim 6, wherein the MCU is configured to, in response to identifying the serial message as malicious, inject the dominant bit into the serial message to overwrite a recessive stuff bit of the serial message to cause the error frame in the serial message transmitted by the second electronic control module.

10. The system of claim 9, wherein:
the serial message includes a CAN ID field; and
the MCU is configured to, in response to identifying the serial message as malicious, inject the dominant bit into the serial message to overwrite the recessive stuff bit of the serial message after the CAN ID field.

11. The system of claim 9, wherein the MCU is configured to, in response to identifying the serial message as malicious, enable pin multiplexing to inject the dominant bit into the serial message to overwrite the recessive stuff bit of the serial message, and disable the pin multiplexing after the dominant bit is injected into the serial message.

12. A method for detecting and preventing, in real time, malicious broadcasting messages from an electronic control module attempting to attack a vehicle network, the method comprising:
receiving, by at least a first electronic control module of a plurality of electronic control modules in communication via a serial data link of the vehicle network, a portion of a serial message on the vehicle network transmitted by a second electronic control module of the plurality of electronic control modules;
identifying the serial message from the second electronic control module as malicious based on the received portion of the serial message; and
in response to identifying the serial message as malicious, injecting a dominant bit into the serial message for the vehicle network to cause an error frame in the serial message transmitted by the second electronic control module.

13. The method of claim 12, wherein identifying the serial message from the second electronic control module as malicious based on the received portion of the serial message includes identifying the serial message from the second electronic control module as malicious based on a unique message identifier (ID) of the serial message.

14. The method of claim 12, wherein the serial data link is a controller area network (CAN) protocol and wherein the plurality of electronic control modules are configured to comply with the CAN protocol.

15. The method of claim 14, wherein:
the serial message on the vehicle network transmitted by the second electronic control module is a first CAN message; and
the method further comprises receiving, by the first electronic control module, a portion of a plurality of second CAN messages on the vehicle network transmitted by the second electronic control module, identifying each of the second CAN messages from the second electronic control module as malicious based on the received portion of each second CAN message, and in response to identifying the CAN message as malicious, injecting a dominant bit into each second CAN message for the vehicle network to cause an error frame in each second CAN message transmitted by the second electronic control module and force the second electronic control module into a bus-off state.

16. The method of claim 15, wherein:
the first electronic control module includes a microcontroller unit (MCU) with an integrated CAN controller, and a CAN transceiver; and
injecting the dominant bit into the serial message for the vehicle network includes injecting, via the CAN transceiver, the dominant bit into the serial message for the vehicle network, thereby bypassing the integrated CAN controller.

17. The method of claim 16, further comprising triggering, by the MCU, an interrupt at a start of frame of the serial message indicated by a bit transition from a recessive bit to a dominant bit during the start of frame, and then triggering, by the MCU, a subsequent main timer interrupt to synchronize the MCU of the first electronic control module with the second electronic control module.

18. The method of claim 13, wherein triggering the subsequent main timer interrupt includes triggering the subsequent main timer interrupt at seventy percent of the nominal bit time of the serial message.

19. The method of claim 16, wherein injecting the dominant bit into the serial message for the vehicle network includes injecting the dominant bit into the serial message to overwrite a recessive stuff bit of the serial message to cause the error frame in the serial message transmitted by the second electronic control module.

20. The method of claim 19, wherein:
the serial message includes a CAN ID frame; and
injecting the dominant bit into the serial message for the vehicle network includes injecting the dominant bit into the serial message to overwrite the recessive stuff bit of the serial message after the CAN ID frame.

21. The method of claim 19, further comprising, in response to identifying the serial message as malicious, enabling pin multiplexing to inject the dominant bit into the serial message to overwrite the recessive stuff bit of the serial message, and disable the pin multiplexing after the dominant bit is injected into the serial message.
